(19) United States
(12) Patent Application Publication
(10) Pub. No.: US 2012/0162539 A1
(43) Pub. Date: Jun. 28, 2012

(54) Remote Controller

(76) Inventors: Masahiro Muramatsu, Saitama (JP); Mikio Kamegi, Kanagawa (JP)

(21) Appl. No.: 13/283,263

(22) Filed: Oct. 27, 2011

(30) Foreign Application Priority Data
Dec. 27, 2010 (JP) 2010-290472

(51) Int. Cl. H04N 5/44

(52) U.S. Cl. 348/734; 348/E05.096

(57) ABSTRACT

According to one embodiment, a remote controller includes substantially rectangular parallelepiped first and second housings and a joint. The first housing includes operation keys on the upper surface to control an object device. The second housing includes input keys on the upper surface to input information and at least one operation button on a surface other than the upper surface. The joint joins the first housing and the second housing to be relatively rotatable about a rotation axis located at a predetermined position such that the upper surface of the second housing faces the bottom surface of the first housing. To operate the input keys, the joint is rotated to a position where a long side of the first housing and a long side of the second housing form substantially the right angle and the input keys are exposed.

### CROSS-REFERENCE TO RELATED APPLICATIONS

This application is based upon and claims the benefit of priority from Japanese Patent Application No. 2010-290472, filed Dec. 27, 2010, the entire contents of which are incorporated herein by reference.

### FIELD

Embodiments described herein relate generally to a remote controller.

### BACKGROUND

Generally, devices such as televisions, video players, digital versatile disc (DVD) players, and set-top boxes can be remotely controlled with a remote controller provided thereto. Such a remote controller has various keys or buttons to activate the functions of the device and an arrow key to move a cursor displayed on the display screen. Besides, there have been proposed conventional remote controllers provided with operation keys or buttons on their sides.

In recent years, there have been available televisions and set-top boxes that can be connected to the Internet, which increases the opportunity for text input. For text input, it is preferable in view of operability that keys be arranged in QWERTY order. On the other hand, careless increase of keys on the remote controller results in an increase in the size and may reduce the operability.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary top view of a remote controller in the closed position according to an embodiment;

FIG. 2 is an exemplary schematic cross-sectional view of the remote controller taken along the line A-A in FIG. 1 in the embodiment;

FIG. 3 is an exemplary bottom view of the remote controller illustrated in FIG. 1 in the embodiment;

FIG. 4 is an exemplary top view of the remote controller in the open position in the embodiment;

FIG. 5 is an exemplary schematic cross-sectional view of the remote controller taken along the line B-B in FIG. 4 in the embodiment;

FIG. 6 is an exemplary bottom view of the remote controller illustrated in FIG. 4 in the embodiment;

FIG. 7 is an exemplary enlarged view of an arrow key and an OK key on the upper housing in the embodiment;

FIG. 8 is an exemplary schematic diagram for explaining how to operate the remote controller in the closed position in the embodiment;

FIG. 9 is an exemplary schematic diagram for explaining how to operate the remote controller in the closed position in the embodiment;

FIG. 10 is an exemplary schematic diagram for explaining how to operate the remote controller in the open position in the embodiment;

FIG. 11 is an exemplary schematic diagram for explaining how to operate the remote controller in the open position in the embodiment;

FIG. 12 is an exemplary schematic diagram for explaining how to operate the remote controller in the open position in the embodiment;

FIG. 13 is an exemplary schematic diagram of a hardware configuration of the remote controller in the embodiment;

FIG. 14 is an exemplary schematic diagram of a remote controller according to a modification of the embodiment; and

FIG. 15 is an exemplary schematic diagram of a remote controller according to another modification of the embodiment.

### DETAILED DESCRIPTION

In general, according to one embodiment, a remote controller comprises substantially rectangular parallelepiped first and second housings and a joint. The first housing comprises operation keys on the upper surface to control an object device. The second housing comprises input keys on the upper surface to input information and at least one operation button on a surface other than the upper surface. The joint is configured to join the first housing and the second housing to be relatively rotatable about a rotation axis located at a predetermined position such that the upper surface of the second housing faces the bottom surface of the first housing. To operate the input keys, the joint is rotated to a position where a long side of the first housing and a long side of the second housing form substantially the right angle and the input keys are exposed.

Exemplary embodiments will be described in detail below with reference to the accompanying drawings. A remote controller described herein is used to remotely control a device, examples of which include a broadcast receiver such as a television, a recorder/player such as a hard disk drive (HDD) recorder, and a set-top box.

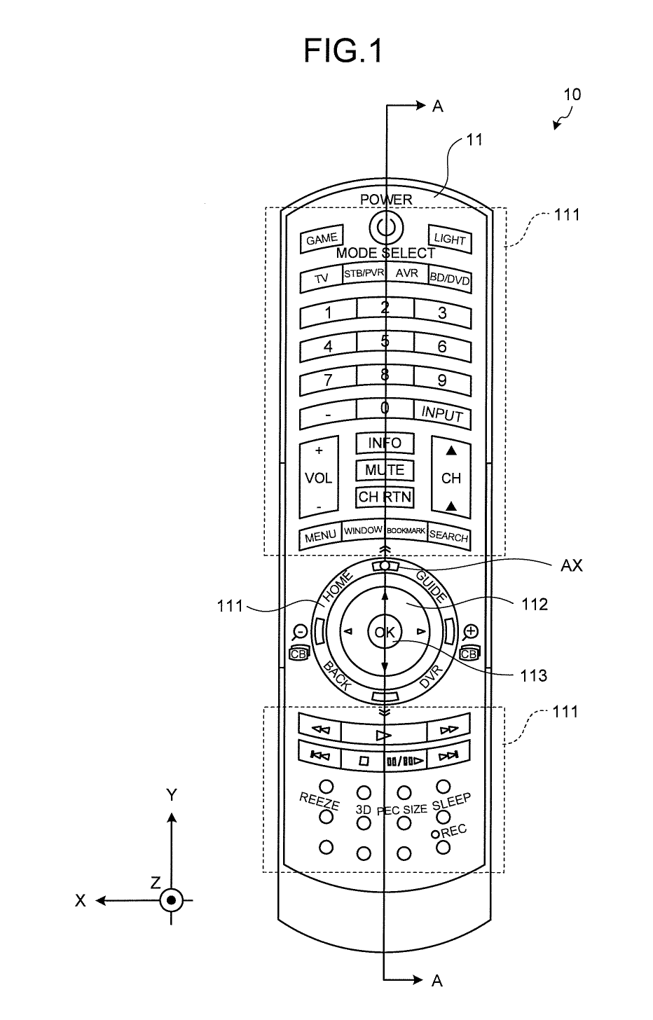

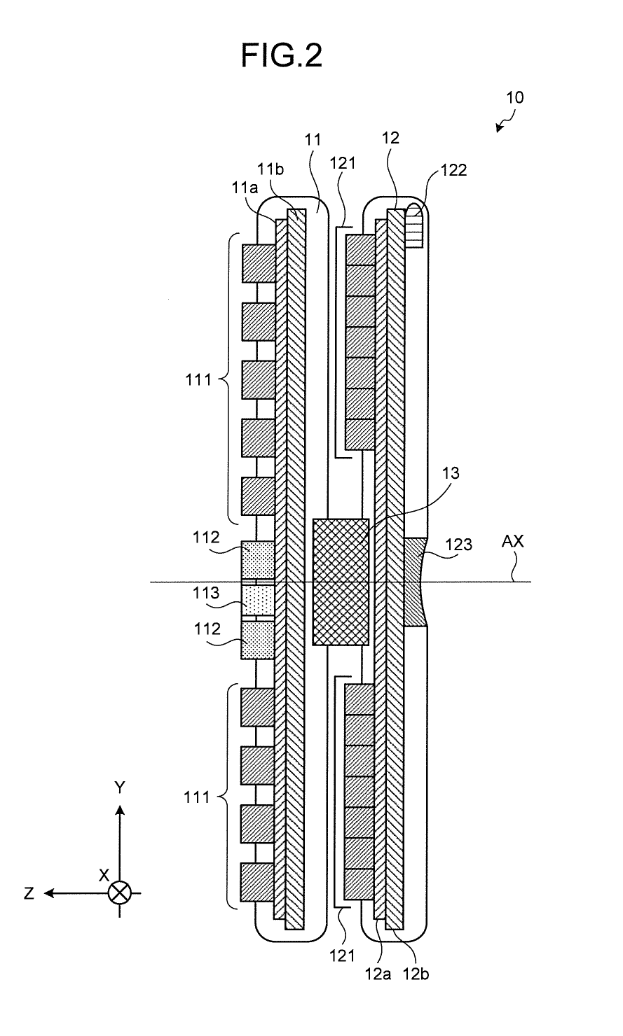

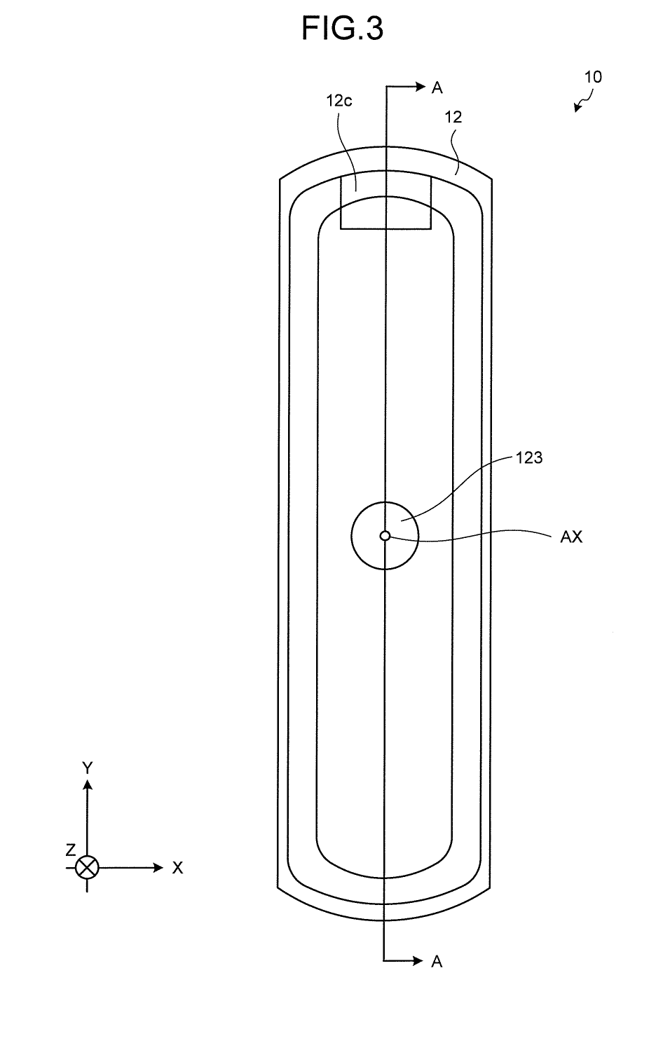

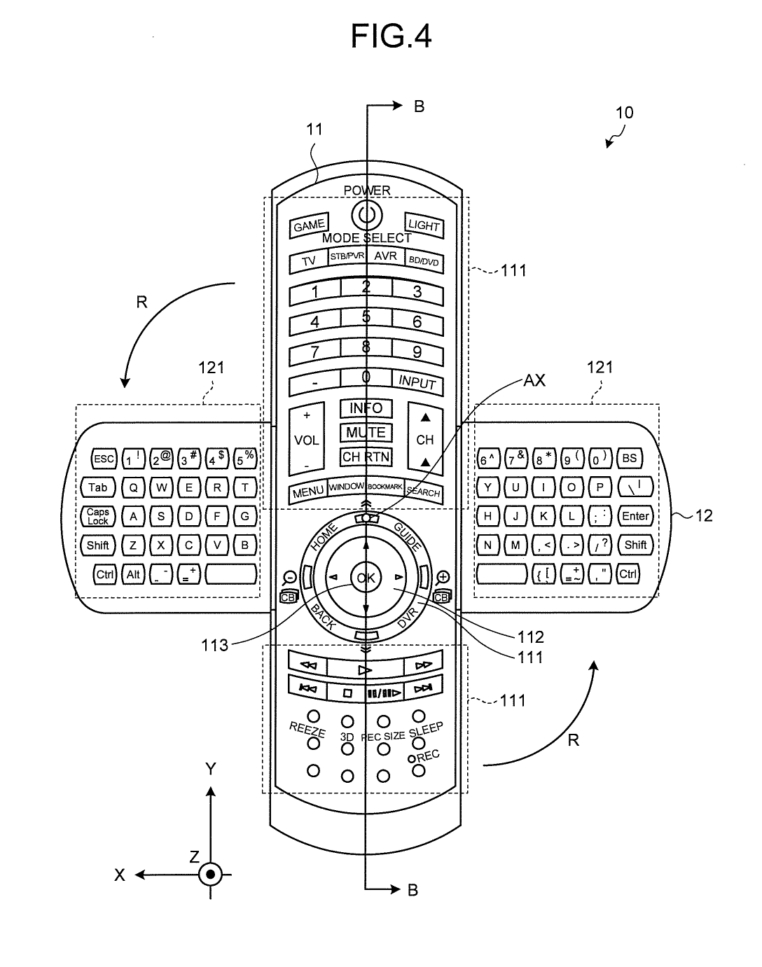

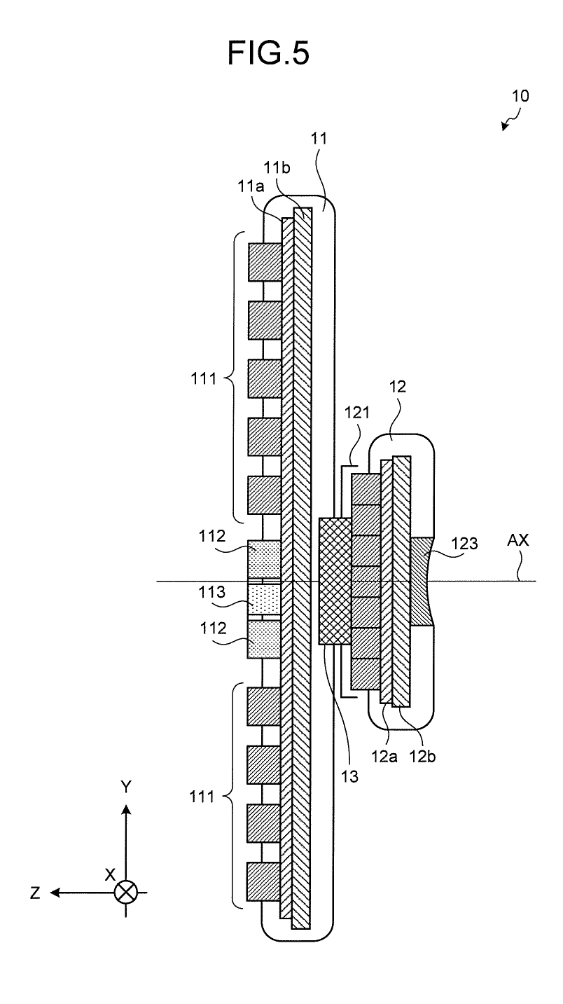

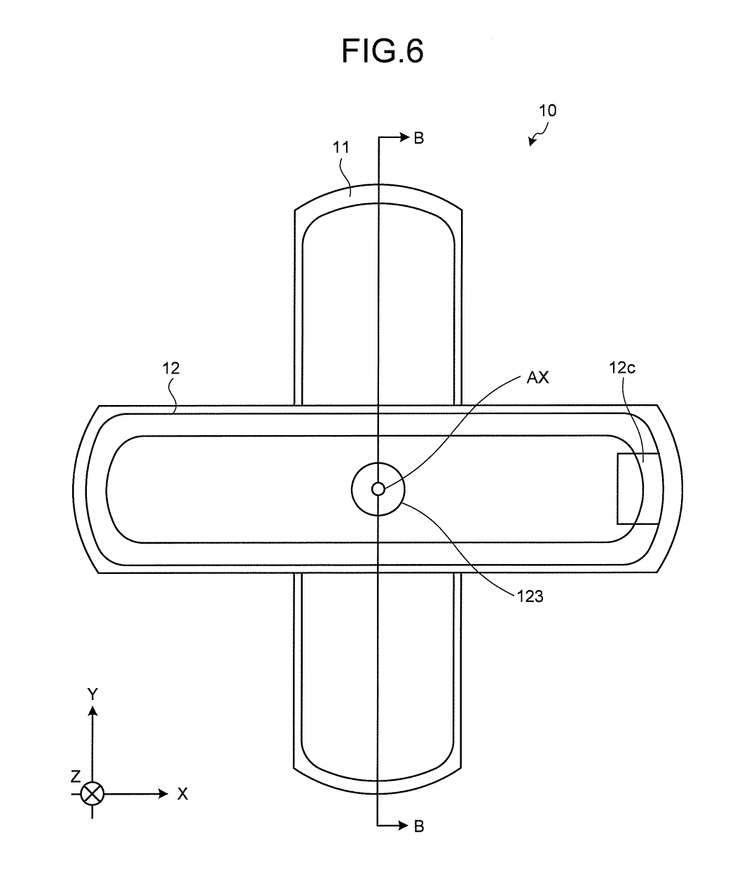

With reference to FIGS. 1 to 6, a description will be given of a basic structure of a remote controller 10 according to an embodiment. FIG. 1 is a top view of the remote controller 10 of the embodiment in the closed position. FIG. 2 is a schematic cross-sectional view of the remote controller 10 taken along the line A-A in FIG. 1. FIG. 3 is a bottom view of the remote controller 10 illustrated in FIG. 1. FIG. 4 is a top view of the remote controller 10 of the embodiment in the open position. FIG. 5 is a schematic cross-sectional view of the remote controller 10 taken along the line B-B in FIG. 4. FIG. 6 is a bottom view of the remote controller 10 illustrated in FIG. 4.

As illustrated in FIGS. 1 to 6, the remote controller 10 comprises a substantially rectangular parallelepiped upper housing 11 as the first housing, a substantially rectangular parallelepiped lower housing 12 as the second housing, and a rotational joint 13 that joins (connects) the upper housing 11 and the lower housing 12 to be relatively rotatable about a rotation axis AX. The upper housing 11 and the lower housing 12 each have substantially the same outer circumference viewed from the direction of the rotation axis AX of the rotational joint 13 (Z axis direction).

The upper surface of the upper housing 11 is an operation surface on which are arranged operation keys 111, an arrow key 112, and an OK key 113. The operation keys 111 are used to activate the main functions of a device to be remotely controlled (hereinafter, “operation device”) such as, for example, channel selection and volume control. The arrow key 112 is used to move a focus (cursor) displayed on the display screen of the operation device. The OK key 113 is located at a position spaced by a predetermined distance in the longitudinal direction (Y axis direction) from substantially the center (the rotation axis AX) on the upper surface of the upper housing 11. As illustrated in FIG. 4, the OK key 113 is located above the upper surface of the second housing when input keys 112 are exposed in the open position.

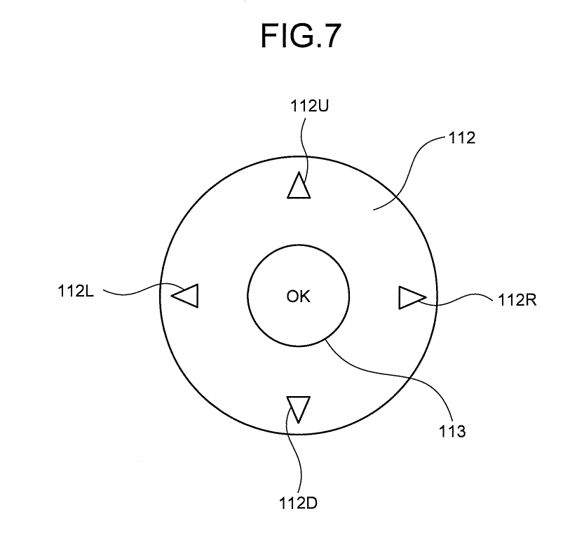

FIG. 7 is an enlarged view of the arrow key 112 and the OK key 113 on the upper housing 11. As illustrated in FIG. 7, the arrow key 112 is shaped in a ring surrounding the OK key 113 and indicates four directions. In this example of the remote controller 10 of the embodiment, the arrow key 112 includes four directional keys, i.e., an up key 112U, a down key 112D, a left key 112L, and a right key 112R. With these four directional keys, it is possible to move a pointer displayed on the display screen of the operation device

The OK key 113 is located in the center of the ring-like arrow key 112. The OK key 113 functions as a pointing device used to move a pointer displayed on the display screen of the operation device. More specifically, the OK key 113 is configured as a pointing stick slidable in the X or Y direction. Sliding of the OK key 113 in any direction moves the pointer displayed on the display screen of the operation device.

Besides, the OK key 113 is configured to be pressed in the vertical direction (Z axis direction). The OK key 113 is pressed to, for example, confirm a selection or action. If a key is operated on the operation surface of the upper housing 11, a signal corresponding to the operation is output to the lower housing 12 through the rotational joint 13.

Referring back to FIGS. 1 to 6, the upper housing 11 houses a key holder 11a and a circuit board 11b. The key holder 11a holds the operation keys 111, the arrow key 112, and the OK key 113 arranged on the operation surface. The circuit board 11b is provided with a reference potential pattern (not illustrated) and the like (see FIGS. 2 and 5).

The upper surface of the lower housing 12 is an operation surface which faces the bottom surface of the upper housing 11 and on which are arranged input keys 121 such as a QWERTY keyboard to input letters or characters. When the user presses one of the input keys 121, a signal (key code) representing a letter, a number, etc. corresponding to the pressed key is sent to the operation device.

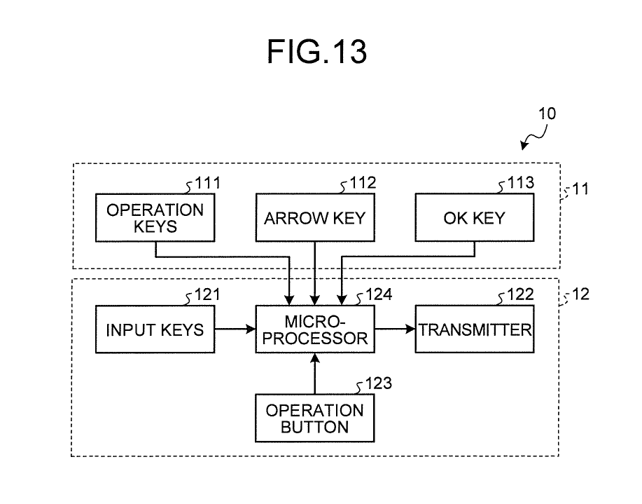

As illustrated in FIG. 2, on the front surface of the lower housing 12 (on the upper side in FIG. 2) is provided a transmitter 122. The transmitter 122 comprises an infrared-ray light emitting diode (LED) or Bluetooth (registered trademark) communication module and the like. A transmission window 12c is formed on the bottom surface of the lower housing 12 to transmit an infrared ray or a radio wave from the transmitter 122. The transmitter 122 is configured to transmit any operation performed by the user on the upper housing 11 or the lower housing 12 to the operation device. As illustrated in FIGS. 2 and 5, the lower housing 12 houses a key holder 12a, a circuit board 12b, and a battery (not illustrated) as a power supply. The key holder 12a holds the input keys 121 arranged on the operation surface. The circuit board 12b is provided with a reference potential pattern (not illustrated), a microprocessor 124 (see FIG. 13), which will be described later, and the like.

The rotational joint 13 joins (connects) the upper housing 11 and the lower housing 12 to be relatively rotatable about the rotation axis AX. The rotation axis AX is located in substantially the center, in the long and short directions, of the upper housing 11 and the lower housing 12.

As illustrated in FIGS. 1 to 3, when the remote controller 10 is in the closed position, the rotational joint 13 holds the upper housing 11 and the lower housing 12 so that their outer circumferences overlap. The rotation of the lower housing 12 in the direction indicated by arrows R in FIG. 4 allows the remote controller 10 to glide into the open position. At this time, the rotational joint 13 rotates to the position where the upper housing 11 and the lower housing 12 form substantially the right angle viewed from the direction of the rotation axis AX (Z axis direction). As a result, the input keys 121 are exposed (see FIG. 4). In this manner, when the input keys 121 are not used, the remote controller 10 can be moved into the closed position where the input keys 121 overlap the upper housing 11. Thus, the remote controller 10 can be made compact.

As illustrated in FIGS. 3 and 6, an operation button 123 is arranged on the bottom surface of the remote controller 10, i.e., the bottom surface of the lower housing 12. The operation button 123 is located in substantially the center, in the long and short directions, of the lower housing 12. In other words, the operation button 123 is located on an extended line of the rotation axis AX of the rotational joint 13.

The operation button 123 is used in combination with another key or button. Operation corresponding to the key combination is transmitted to the operation device. The operation surface of the operation button 123 (on the side of the bottom surface of the lower housing 12) is flush with or recessed from the bottom surface of the lower housing 12. This shape prevents the operation button 123 from being pressed by mistake when the remote controller 10 is laid with the bottom facing down.

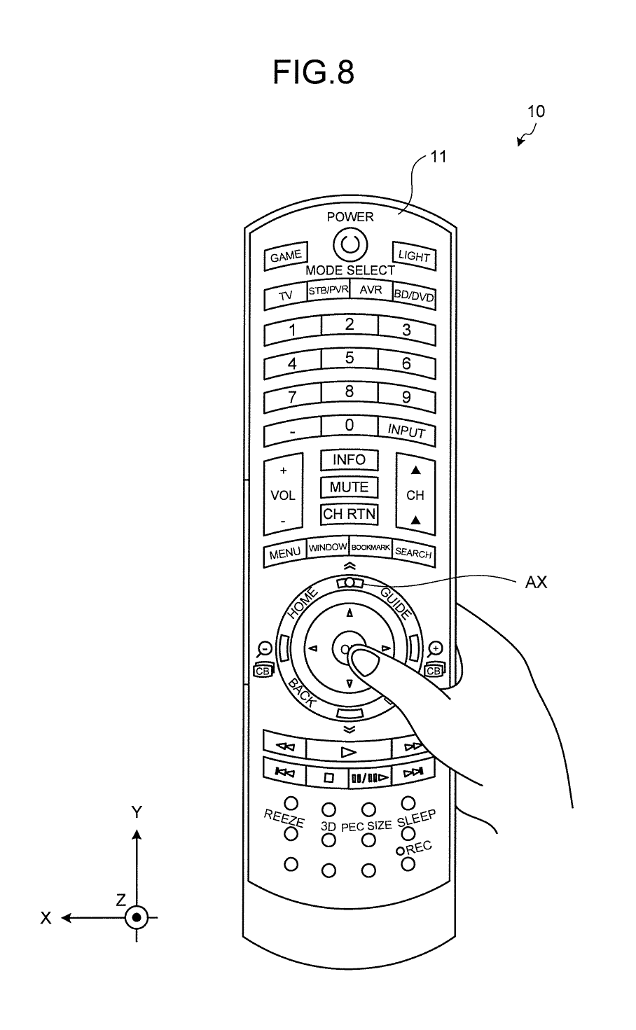

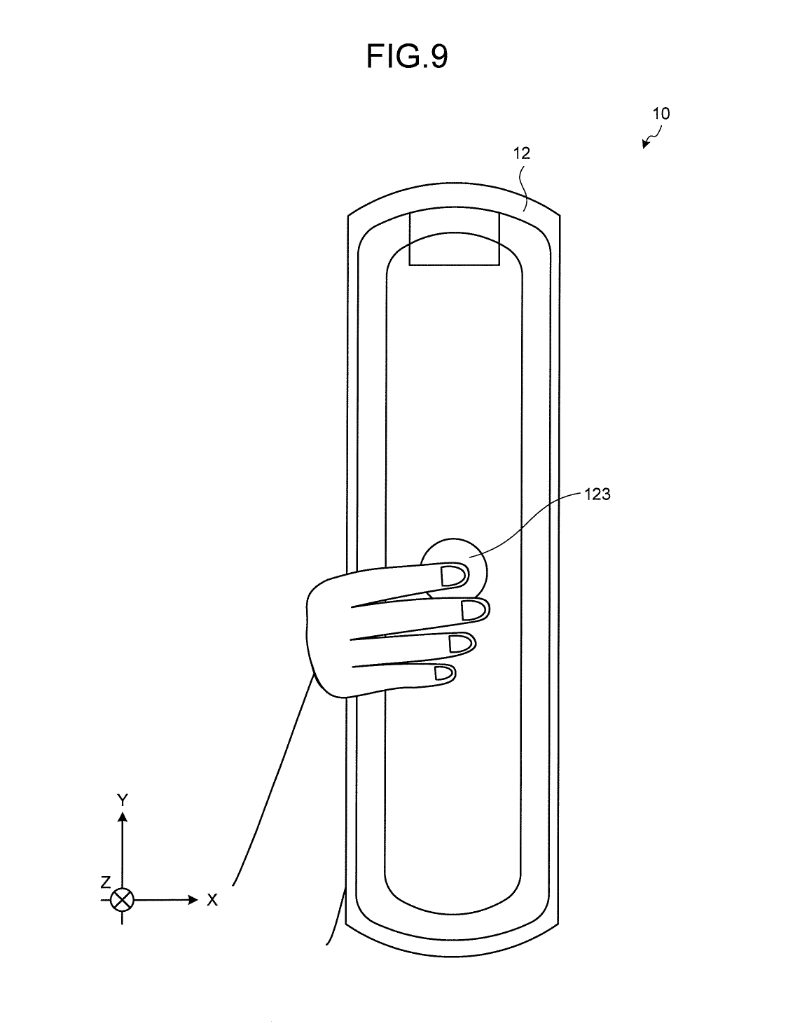

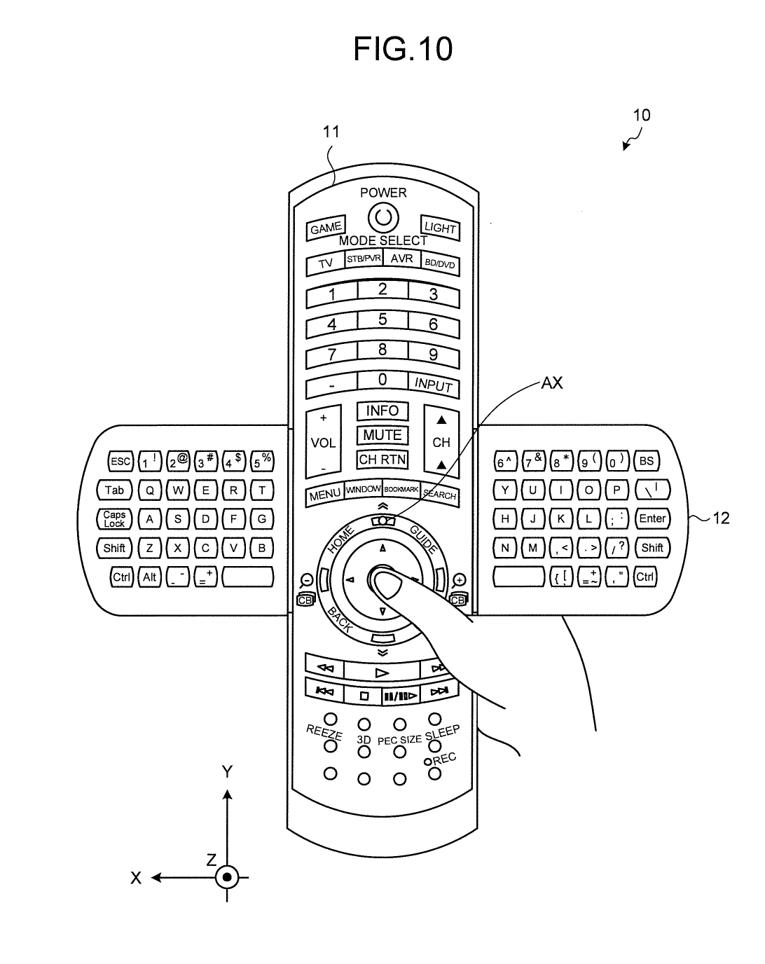

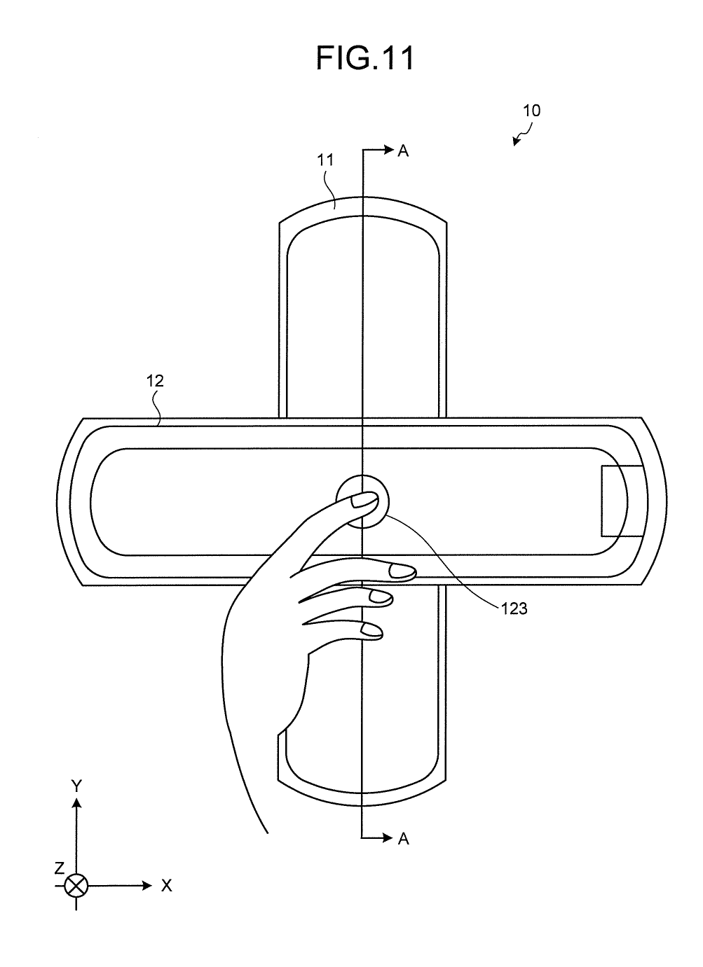

In the following, a description will be given of how to operate the remote controller 10 in the open and closed positions. FIGS. 8 and 9 are schematic diagrams for explaining how to operate the remote controller 10 in the closed position. FIGS. 8 and 9 correspond to FIGS. 1 and 3, respectively. FIGS. 10 and 11 are schematic diagrams for explaining how to operate the remote controller 10 in the open position. FIGS. 10 and 11 correspond to FIGS. 4 and 6, respectively.

When the remote controller 10 is in the closed position, as illustrated in FIGS. 8 and 9, the user can operate each key on the operation surface of the upper housing 11 by his/her thumb while holding the remote controller 10 with one hand. The operation button 123 is located at a position corresponding to the position of user's finger placed on the bottom surface of the lower housing 12 (see FIG. 9) when the user holds the remote controller 10 with one hand near the center (see FIG. 9). If the remote controller 10 is in the open position, the operation button 123 is also located at a position corresponding to the position of user's finger placed on the bottom surface of the lower housing 12 when the user holds the remote controller 10 with one hand at a position where the upper housing 11 and the lower housing 12 cross as illustrated in FIG. 10 (see FIG. 11).

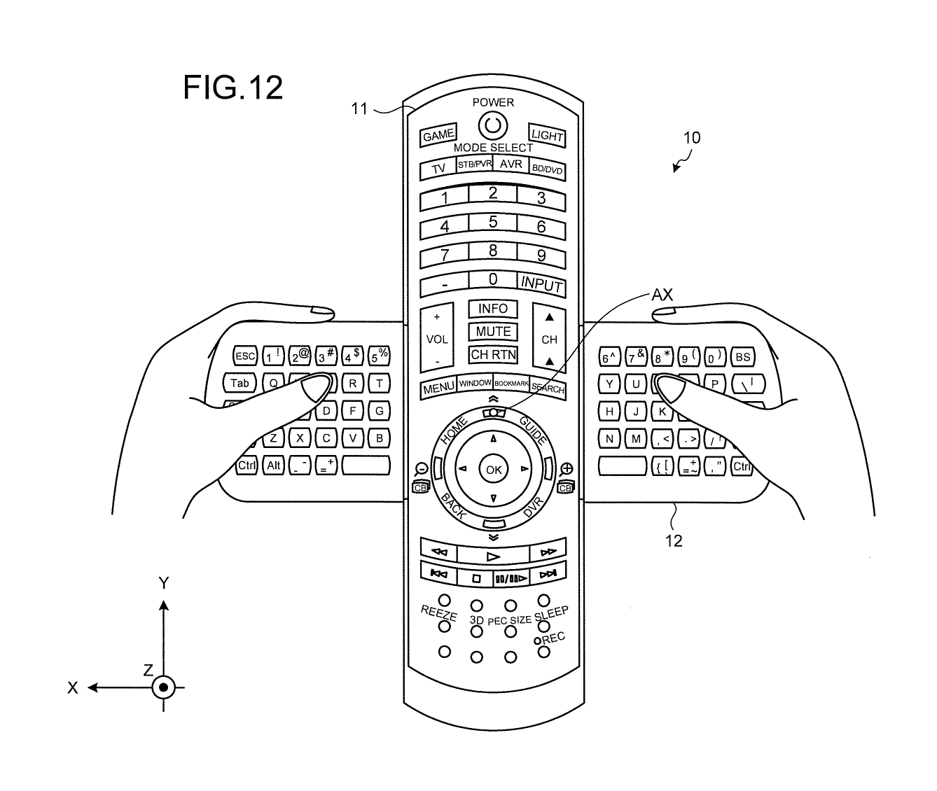

As described above, the remote controller 10 is configured such that the user can easily operate the operation button 123 on the bottom surface of the lower housing 12 while holding the remote controller 10 with one hand. Thus, the operation button 123 can be used in combination with the OK key 113 with improved operability. Besides, the operation button 123 is located on an extended line of the rotation axis AX of the rotational joint 13. Accordingly, the relative position of the operation button 123 does not change between the open and closed positions of the remote controller 10. With this, when the remote controller 10 is moved into the open to closed position or vice versa, the user can continue to operate the operation button 123 without moving the position of the finger on the operation button 123. This further improves the operability. In the case where the user operates the input keys 121 on the lower housing 12 when the remote controller 10 is in the open position, as illustrated in FIG. 12, he/she operates them by both thumbs while holding the lower housing 12 with both hands on the short sides.

With reference to FIG. 13, a description will be given of the hardware configuration of the remote controller 10. FIG. 13 is a schematic diagram of an example of the hardware configuration of the remote controller 10. As illustrated in FIG. 13, the remote controller 10 comprises the operation keys 111, the arrow key 112, and the OK key 113 in the upper housing 11. Besides, the remote controller 10 comprises the input keys 121, the transmitter 122, the operation button 123, and the microprocessor 124 in the lower housing 12.

The microprocessor 124 is a controller that controls the overall operation of the remote controller 10. The microprocessor 124 receives a key operation performed by the user and outputs a signal corresponding to the key operation to the remote controller 10 through the transmitter 122.

More specifically, if the user slides the OK key 113 without pressing the operation button 123, the microprocessor 124 transmits an instruction signal to move a pointer displayed on the display screen of the operation device to a position corresponding to the slide operation. On the other hand, if the user slides the OK key 113 while pressing the operation button 123, the microprocessor 124 transmits an instruction signal to drag an object at the position of a pointer displayed on the display screen of the operation device to a position corresponding to the slide operation. Incidentally, the function of the operation button 123 is not limited to these examples.

As described above, according to the embodiment, the remote controller 10 comprises the upper housing 11 and the lower housing 12 which are connected by the rotational joint 13 to be relatively rotatable. Thus, the remote controller 10 can be moved into the closed position to be compact in size. The remote controller 10 can be moved into the open position by rotating the first and second housings such that the long sides of the housings form substantially the right angle. With this, the input keys 121 are exposed, and thereby the user can use the keys (the operation keys 111, the arrow key 112, and the OK key 113) on the upper housing 11 together with the input keys 121 on the lower housing 12. This improves the operability of the remote controller 10. Besides, the operation button 123 is provided on the bottom surface of the remote controller 10 (the lower housing 12). This allows the user to operate the remote controller 10 with a finger placed on the bottom surface of the remote controller 10 (the lower housing 12). Thus, the operability of the remote controller 10 can be further improved.

While, in the above embodiment, the upper housing 11 and the lower housing 12 are joined so that they are relatively rotatable about the rotation axis AX located in substantially the center of the upper housing 11 and the lower housing 12, it is not so limited. The rotation axis AX may be located in any other part.

While the operation button 123 is described above as being a single button located in a position corresponding to the rotation axis AX on the bottom surface of the lower housing 12, it is not so limited. The operation button 123 may be provided to another position or surface.

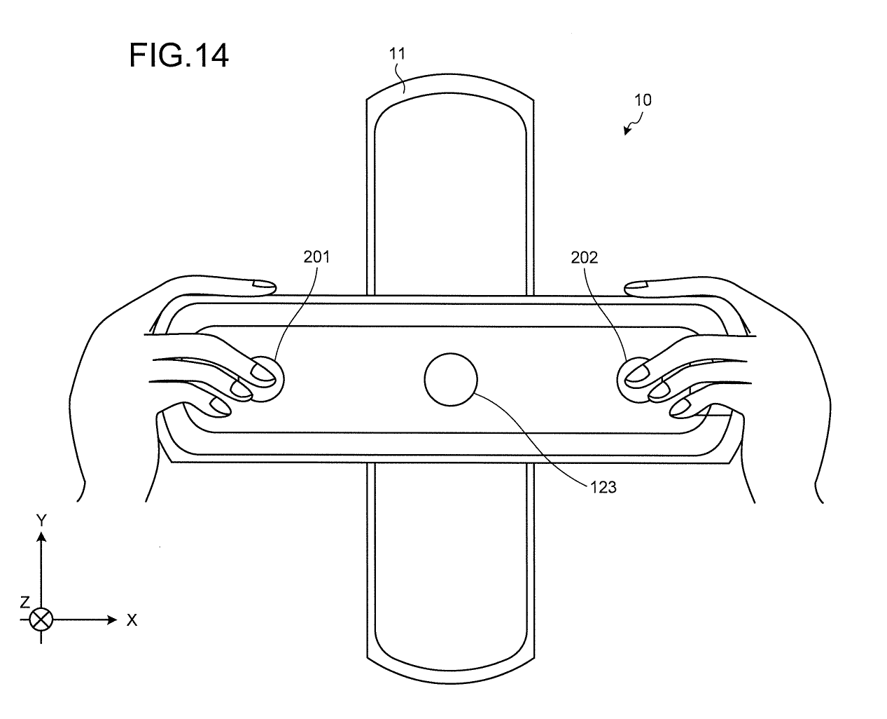

For example, as illustrated in FIG. 14, a pair of operation buttons 201 and 202 may be provided at symmetric positions in the longitudinal direction on the bottom surface of the lower housing 12. FIG. 14 is a schematic diagram of the remote controller 10 according to a modification of the embodiment. FIG. 14 illustrates the bottom surface of the remote controller 10 in the open position. As illustrated in FIG. 14, preferably, the operation buttons 201 and 202 are each located at a position where the user places his/her finger (for example, middle finger) on the bottom surface of the lower housing 12 while holding the lower housing 12 with both hands. With this configuration, the user can easily operate the operation buttons 201 and 202 while holding the lower housing 12 with both hands. Thus, the operability of the remote controller 10 can be further improved.

While, in the example of FIG. 14, the operation buttons 201 and 202 are provided together with the operation button 123, it is not so limited. There may be provided only the operation buttons 201 and 202. Besides, preferably, the operation surface of the operation buttons 201 and 202 is flush with or recessed from the bottom surface of the lower housing 12. This shape prevents the operation buttons 201 and 202 from being pressed by mistake when the remote controller 10 is laid with the bottom facing down.

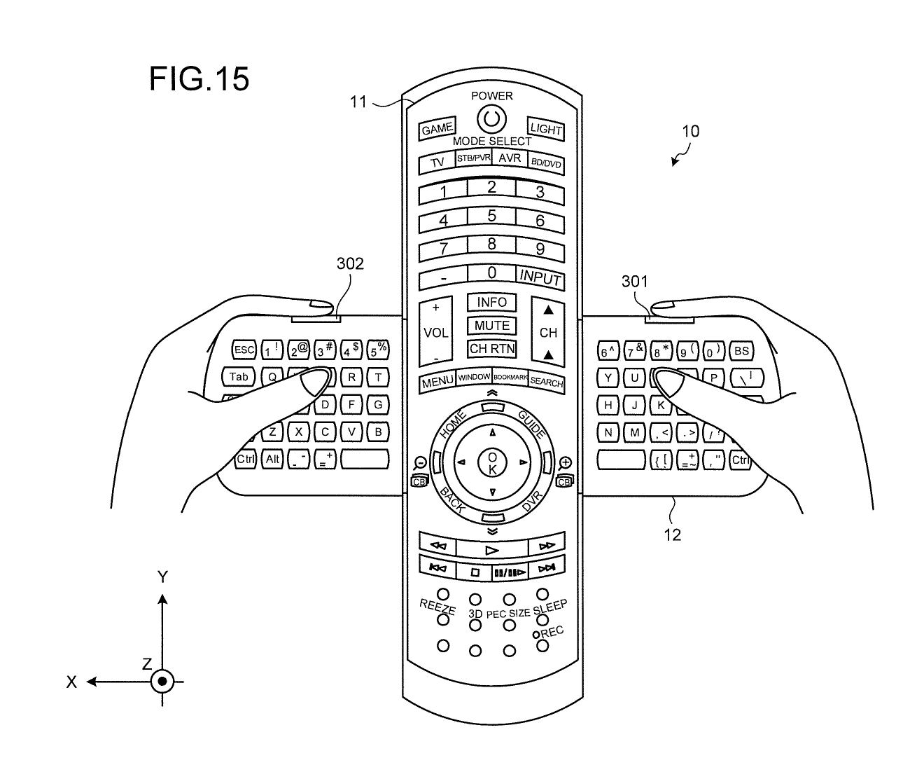

For another example, as illustrated in FIG. 15, a pair of operation buttons 301 and 302 may be provided on a long side surface of the lower housing 12. FIG. 15 is a schematic diagram of the remote controller 10 according to another modification of the embodiment. FIG. 15 illustrates the front surface of the remote controller 10 in the open position. As illustrated in FIG. 15, preferably, the operation buttons 301 and 302 are each located at a position where the user places his/her finger (for example, middle finger) on the side surface of the lower housing 12 while holding the lower housing 12 with both hands. With this configuration, the user can easily operate the operation buttons 301 and 302 while holding the lower housing 12 with both hands. Thus, the operability of the remote controller 10 can be further improved.

Besides, preferably, the operation surface of the operation buttons 301 and 302 is flush with or recessed from the side surface of the lower housing 12. This shape prevents the operation buttons 301 and 302 from being pressed by mistake when the remote controller 10 is held.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A remote controller comprising:
a substantially rectangular parallelepiped first housing comprising operation keys on an upper surface to control an object device;
a substantially rectangular parallelepiped second housing comprising input keys to input letters on an upper surface and at least one operation button on a surface other than the upper surface; and
a joint configured to join the first housing and the second housing to be relatively rotatable about a rotation axis located at a predetermined position such that the upper surface of the second housing faces a bottom surface of the first housing, wherein
to operate the input keys, the joint is rotated to a position where a long side of the first housing and a long side of the second housing form substantially a right angle and the input keys are exposed.

2. The remote controller of claim 1, wherein the operation button is located in a position corresponding to the rotation axis on a bottom surface of the second housing.

3. The remote controller of claim 1, wherein the rotation axis is located in substantially a center of the first housing and the second housing.

4. The remote controller of claim 3, wherein
the operation keys on the first housing include a determination key to confirm a selection, and
the determination key is located at a position spaced by a predetermined distance in a longitudinal direction from substantially the center of the upper surface of the first housing, above the upper surface of the second housing when the input keys are exposed.

5. The remote controller of claim 1, wherein the operation button includes a pair of operation buttons located at symmetric positions in a longitudinal direction on a bottom surface of the second housing.

6. The remote controller of claim 1, wherein the operation button includes a pair of operation buttons located at symmetric positions in a longitudinal direction on a side surface of the second housing.

7. The remote controller of claim 5, wherein the operation buttons are each located at a position where a user who operates the input keys places a finger.

8. The remote controller of claim 6, wherein the operation buttons are each located at a position where a user who operates the input keys places a finger.

9. The remote controller of claim 1, wherein an operation surface of the operation button is flush with or recessed from a surface where the operation button is located.

10. The remote controller of claim 1, wherein the first housing and the second housing are provided with substantially identical outer circumference viewed from direction of the rotation axis of the joint.
